(19) United States
(12) Patent Application Publication
(10) Pub. No.: US 2015/0187454 A1
(43) Pub. Date: Jul. 2, 2015

(54) ELECTROCONDUCTIVE PARTICLES

(71) Applicant: Mitsui Mining & Smelting Co., Ltd., Tokyo (JP)

(72) Inventors: Hiroyuki ISEKI, Yamaguchi (JP); Yoshio MAWATARI, Yamaguchi (JP)

(21) Appl. No.: 14/582,375

(22) Filed: Dec. 24, 2014

(30) Foreign Application Priority Data
Dec. 26, 2013 (JP) 2013-270235

(51) Int. Cl. H01B 1/20; H01B 1/08

(52) U.S. Cl. CPC H01B 1/20; H01B 1/08

(57) ABSTRACT

An electroconductive particle is composed of a core particle and tin oxide containing at least one element whose valence is equal to or smaller than four and located on the surface of the core particle. The tin oxide containing at least one element whose valence is equal to or smaller than four has a crystallite size of 5 to 20 nm. The element whose valence is equal to or smaller than four is preferably an element of the group 1 of the Periodic Table, an element of the group 2 of the Periodic Table, an element of the group 4 of the Periodic Table, an element of the group 12 of the Periodic Table, or an element of the group 13 of the Periodic Table. The content of the element whose valence is equal to or smaller than four is preferably 0.045 mol % to 20 mol % relative to tin.

### TECHNICAL FIELD

This invention relates to an electroconductive particle having an electroconductive surface layer containing tin oxide.

### BACKGROUND ART

It is known that a non-electroconductive material, such as plastics, may be rendered electroconductive by the addition of a material capable of imparting electrical conductivity. Examples of such materials capable of imparting electrical conductivity include surfactants and electroconductive powders, such as metal powders, carbon black, tin oxide power doped with antimony or a like dopant, particles having a coating layer of tin oxide doped with antimony or a like dopant, and particles composed of a titanium oxide or barium sulfate core and a tin oxide coating layer. Addition of a surfactant to, e.g., plastics sometimes results in variations of electroconductivity of the resulting plastics with temperature and humidity. Addition of metal powder or carbon black to plastics makes the plastics black, which may limit the use of the plastics. The coloration problem does not occur with the other electroconductive powders, such as tin oxide power doped with antimony or a like dopant, particles having a coating layer of tin oxide doped with antimony or a like dopant, and particles having a titanium oxide or barium sulfate core and a tin oxide coating layer. In particular, the particles having a titanium oxide or barium sulfate core and a tin oxide coating layer have an additional advantage of low environment dependency of electroconductivity, namely high environmental resistance. Today, the environments in which electroconductive powder is used are being diversified, so that in some cases the conventional electroconductive powders cannot be said to have sufficient environment resistance.

As discussed in Patent Literature 1 (see below), diverse electroconductive particles have been demanded which have characteristics such as dispersibility and resistivity varied according to the resins or plastics to which they are added or the intended use.

With regard to the particles having a titanium oxide or barium sulfate core and a tin oxide coating layer, the technique of incorporating another element into the tin oxide coating layer is known. For example, Patent Literature 2 below proposes incorporating Si, Ge, Zr, Ti, Hf, Al, P, B, Pb, etc. into a tin oxide coating layer. Patent Literature 3 below teaches incorporating Co, Ni, Cu, Al, etc. into a tin oxide coating layer. Patent Literature 4 proposes incorporating Ga or Al. According to these Patent Literatures, however, the aim of incorporating other elements into a tin oxide coating layer is not to improve the environment resistance of the electroconductive particles.

### CITATION LIST

### Patent Literature

Patent Literature 1: JP 2013-136675A
Patent Literature 2: JP 11-292535A
Patent Literature 3: JP 2003-128417A
Patent Literature 4: JP 2011-506700A

### SUMMARY OF INVENTION

An object of the invention is to improve the performance properties of an electroconductive particle having tin oxide on its surface.

The invention provides an electroconductive particle comprising a core particle and tin oxide containing at least one element whose valence is equal to or smaller than four and located on the surface of the core particle. The tin oxide containing at least one element whose valence is equal to or smaller than four has a crystallite size of 5 nm to 20 nm.

The invention also provides an electroconductive composition comprising a tin oxide particle containing at least one element whose valence is equal to or smaller than four and a core particle. The tin oxide containing at least one element whose valence is equal to or smaller than four has a crystallite size of 5 nm to 20 nm.

According to the invention, electroconductive particles having high environment resistance are provided.

### DESCRIPTION OF EMBODIMENTS

As used herein, the term “electroconductive particles” refers to either individual particles or powder as an aggregate of particles, which depends on the context. The electroconductive particle of the invention is divided into a central portion and a surface portion located outer side of the central portion. A core particle is located in the central portion. An electroconductive tin oxide surface layer as the surface portion is formed so as to cover the surface of the core particle. The core particle occupies a major portion of the volume of the electroconductive particle of the invention. The surface layer is located on the outermost surface of the electroconductive particle of the invention. The electroconductive tin oxide surface layer preferably covers the entire surface of the core particle.

It is preferred that the electroconductive tin oxide forming the surface layer is composed mainly of an oxide of tetravalent tin. Presence of a small amount of divalent tin in the electroconductive tin oxide is permissible as long as the electroconductivity of the particles is not impaired.

One of the characteristics possessed by the electroconductive particles of the invention resides in the electroconductive tin oxide that constitutes the surface layer. The electroconductive tin oxide contains an additional element the valence of which is equal to or smaller than four, the valence of the tin of the tin oxide. The inventors have found that the tin oxide containing an additional element whose valence is equal to or smaller than four (i.e., tetravalent or lower valent than tetravalent, hereinafter also referred to as a lower valent element) has lower dependence of electroconductivity on the environment than the tin oxide containing no such an additional element. Specifically, it has been found that the tin oxide containing a lower valent element is less liable to reduce its electroconductivity even when left to stand in a severe environment, such as a high temperature or a high humidity, for a long period of time. As a result of study, however, the inventors have ascertained that the tin oxide containing a lower valent element has a different crystallite size from a tin oxide containing no lower valent element. In particular, as a result of study, the inventors have ascertained that in the case where the crystallite size of tin oxide decreases when an added amount of a lower valent element increases, the tin oxide tends to have increased environment dependence of electroconductivity. To put it another way, as a result of study, the inventors have ascertained that addition of a lower valent element to tin oxide can sometimes bring about both improvement in environment resistance and reduction in environment resistance that is ascribed to the reduction in crystallite size. The inventors have continued study aiming at further increasing the environment resistance of tin oxide and found that the environment resistance of tin oxide can be improved by minimizing the reduction of crystallite size caused by the addition of a lower valent element. On the other hand, in the case where the crystallite size of the tin oxide increases when an added amount of a lower valent element increases, the environment resistance increases with the increase in crystallite size. Thus, it is a concept of this invention to increase, compared with a tin oxide containing no lower valent element, the ratio of change (ratio of increase) in crystallite size of tin oxide containing a lower valent element thereby to improve environment resistance of the tin oxide. Whether addition of a lower valent element to tin oxide results in an increase or decrease of crystallite size of the tin oxide depends on the lower valent element added.

As discussed above, addition of some lower valent elements to tin oxide tends to result in reduction of crystallite size of the tin oxide. From the viewpoint of improving environment resistance of tin oxide, a larger crystallite size is better for environment resistance. When in using a lower valent element that tends to decrease the crystallite size of tin oxide to which it is added, the reduction in crystallize size of tin oxide due to the addition of the lower valent element may be minimized by producing the electroconductive particles of the invention by the methods hereinafter described. It has been ascertained that sufficiently high environment resistance is obtained as long as the crystallite size is 5 nm or greater. As the crystallite size of tin oxide becomes greater, higher environment resistance is obtained as noted above, but the intended object of the invention is accomplished when the crystallite size is as large as about 20 nm. Therefore, a desired crystallite size of tin oxide is 5 nm to 20 nm, more desirably 6 nm to 20 nm.

The crystallite size of electroconductive tin oxide constituting the surface layer of the electroconductive particles of the invention is determined as follow. XRD analysis is performed using an X-ray diffractometer Ultima IV (from Rigaku Corp.) under the following conditions: X-ray CuKα radiation (40 kV, 50 mA); measurement range 20°≦2θ≦100°; ray source, CuKα; scanning axis, 2θ/θ; measurement mode: fixed time; counting unit: count; step size: 0.01°; count time: 10 seconds; divergence slit: ⅔°; Soller slit (restricting vertical divergence): 10 mm; scatter slit: ⅔°; receiving slit: 0.3 mm; receiving slit at the monochromator: 0.8 mm. Then, the thus obtained data are analyzed by software PDXL available from Rigaku (ICDD card of SnO₂: 00-046-1088 is used) and are refined. The crystallite size is determined by the Halder-Wagner method based on the refined data. Width correction is performed based on an external standard substance. Analysis parameters are crystallite size and lattice strain.

As a result of the inventor's investigation, addition of even a small amount of a lower valent element to tin oxide has been found contributory on the improvement of environment resistance. Adding too much amount of a lower valent element tends to result in reduction of productivity and increase of production cost. Then, the amount of the lower valent element to be added to tin oxide is preferably such that the resulting electroconductive tin oxide which contains the lower valent element may have a lower valent element content of 0.045 mol % to 20 mol %, more preferably 0.1 mol % to 20 mol %, relative to tin. The content of the lower valent element is obtained by ICP emission spectrometry on a solution prepared by dissolving the electroconductive particles in an acid, e.g., sulfuric acid.

The lower valent element is an element the valence of which is equal to or smaller than four, the valence of tetravalent tin. Examples of the lower valent elements include an element of the group 1 of the Periodic Table, an element of the group 2 of the Periodic Table, an element of the group 12 the Periodic Table, or an element of the group 13 of the Periodic Table. More specifically, the element of the group 1 of the Periodic Table includes sodium, potassium, and lithium; the element of the group 2 of the Periodic Table includes magnesium, calcium and barium; the element of the group 4 of the Periodic Table include titanium, zirconium, and hafnium; the element of the group 12 of the Periodic Table include zinc; and the element of the group 13 of the Periodic Table include boron, aluminum, and gallium.

The lower valent elements described are classified according to the valency into tetravalent, i.e., titanium, zirconium, and hafnium; trivalent, i.e., boron, aluminum, and gallium; divalent, i.e., zinc, magnesium, calcium and barium; and monovalent, i.e., sodium, potassium, and lithium. Preferred of them are zinc and aluminum in view of their high performance of improving the environment resistance. In using zinc as a lower valent element, the crystallite size of tin oxide increases with the amount of addition whilst when using aluminum, on the other hand, the crystallite size of tin oxide decreases with the amount of addition, as will be demonstrated in Examples hereinafter described.

The above discussed lower valent elements may be used either individually or in combination of two or more thereof. In the latter case, the elements to be combined may have the same or different valence, and the above described preference for the lower valent element content relative to tin applies to the total content of all the lower valent elements added.

The electroconductive tin oxide constituting the surface layer of the electroconductive particles may further contain a higher than tetra-valent element (hereinafter also referred to as a higher valent element) in addition to the lower valent elements. Examples of such a higher valent element include antimony, niobium, tantalum, tungsten, and phosphorus. The higher valent element is used solely for the purpose of increasing the electroconductivity of the electroconductive tin oxide. From the standpoint of ensuring the advantage of incorporating the lower valent element into the electroconductive tin oxide, the electroconductive tin oxide is preferably free from a higher valent element. Nevertheless, it is acceptable that such a small amount of a higher valent element as to be difficult to remove is present in the electroconductive particles as a result of unintentional incorporation during the process of producing the electroconductive particles.

In order to increase the electroconductivity of the electroconductive particles, it is preferred that the electroconductive tin oxide surface layer continuously cover the entire surface of the core particle so that the surface of the core particle is not at all exposed. It is acceptable, nonetheless, that the coverage by the surface layer is discontinuous to permit part of the surface of the core particle to be exposed as long as the effect of the invention is not ruined.

The thickness of the electroconductive tin oxide surface layer does not need to be excessively thick so long as the electroconductivity of the surface layer is sufficiently exhibited. The thickness of the surface layer in terms of the amount of tin oxide is preferably such that the proportion of tin oxide in the electroconductive particles is 10 mass % to 60 mass %, more preferably 20 mass % to 60 mass %, even more preferably 25 mass % to 50 mass %. The amount of tin in the electroconductive particles can be obtained by ICP emission spectrometry on a solution prepared by dissolving the surface layer of the electroconductive particles in an acid.

The electroconductive particles of the invention preferably have a BET specific surface area of 10 m²/g to 60 m²/g. The electroconductive particles having a BET specific surface area falling within the range recited have a small particle size for good loadability in resins and good dispersibility in resins and therefore provide an electroconductive film with increased electroconductivity. Because electroconductive particles with small particle sizes have small interaction with light, the electroconductive film prepared therefrom may have reduced bluish tint. From all these considerations, a more preferred BET specific surface area of the electroconductive particles is 13 m²/g to 50 m²/g. The BET specific surface area is measured using, for example, Monosorb from Yuasa Ionics Co., Ltd.

In connection with the BET specific surface area, the electroconductive particles of the invention preferably have an average primary particle size of 30 nm to 700 nm, more preferably 50 nm to 500 nm, as measured by transmission electron microscopic observation. The average primary particle size as referred to here is an average calculated by measuring the Feret's diameters of at least 100 primary particles under a transmission electron microscope. The electroconductive particles of the invention preferably have a particle size D₅₀ (a diameter at 50% cumulative volume in the particle size distribution measured by a laser diffraction scattering method) of 0.1 μm to 2.0 μm, more preferably 0.2 μm to 1.5 μm, even more preferably 0.3 μm to 1.3 μm. The electroconductive particles having the average primary particle size and the D₅₀ within the respective ranges recited are easy to disperse in resins and the like. The sample for measurement is prepared by dispersing 0.1 g of the electroconductive particles in 100 ml of a 20 mg/L aqueous solution of sodium hexametaphosphate in an ultrasonic homogenizer US-300T from Nihonseiki Kaisha Ltd. for 10 minutes. Measurement may be taken using, for example, a laser diffraction scattering particle size analyzer, LA-920 from Horiba, Ltd.

The electroconductive particles of the invention have relatively high powder resistivity under pressure in spite of their electroconductivity. Specifically, the powder resistivity under pressure of the electroconductive particles of the invention at 25° C. is preferably 1.0×10² Ω·cm to 1.0×10¹² Ω·cm, more preferably 1.0×10⁴ Ω·cm to 1.0×10¹⁰ Ω·cm. Powder resistivity under pressure is measured using, for example, a powder resistivity measuring system PD-41 and a resistivity meter MCP-T600, both from Mitsubishi Chemical Corp. Specifically, a sample weighing 5 g is put in a probe cylinder, and the probe unit is set on PD-41. A load of 500 kgf is applied to the sample using a hydraulic jack for 0.5 minutes to obtain a cylindrical pellet having a diameter of 25 mm. The resistivity of the obtained pellet is measured with MCP-T600. A powder resistivity under pressure is calculated from the measured ohmic value and the sample thickness.

Not only do the electroconductive particles of the invention per se have a relatively high powder resistivity under pressure, but also a coating film containing the electroconductive particles exhibits a relatively high surface resistivity. Furthermore, the surface resistivity of the coating film exhibits high environment resistance. Specifically, when an electroconductive film formed by using the electroconductive particles of the invention together with a resin and a solvent is stored at 60° C. and 90% RH for 30 days, the ratio of the post-storage resistivity R_{HH} (Ω/sq.) to the pre-storage resistivity R (Ω/sq.), R_{HH}/R, which will hereinafter be referred to as a surface resistivity change, is preferably 6 or less, more preferably 5 or less, even more preferably 3 or less.

The surface resistivities R and R_{HH} of an electroconductive film, from which the surface resistivity change is calculated, are measured by the following method. A 50 ml volume plastic container is provided. In the container is put 5.48 g of electroconductive particles, and 9.64 g of a 7:3 by volume mixed solvent of toluene and n-butanol is then added thereto. To the container is further added 6.41 g of an acrylic coating resin Dianal LR-167 (composed of a resin component of about 46 mass % and the balance of a mixed solvent of toluene and n-butanol) from Mitsubishi Rayon Co., Ltd. The contents were dispersed on a paint shaker from Asada Iron Works, Co., Ltd. for 4 hours. The paint shaker is operated under a 60 Hz environment. The coating composition obtained by dispersing is applied to an aluminum foil having a thickness of 50 μm (available from FUKUDA METAL FOIL & POWDER Co., LTD.) using SA-201 bar coater available from Tester Sangyo Co., Ltd, to obtain a coating film having a thickness of 20 μm. After obtaining the coating film, the coating film is dried in the atmosphere at 80° C. for 60 minutes to obtain an electroconductive film. The surface resistivity of the resulting electroconductive films is measured at a measuring voltage of 10 V using a resistometer Hiresta with an UP probe from Mitsubishi Chemical Analytech Co., Ltd. The measurement is taken at 10 different positions of the film to obtain an average.

The surface resistivity of an electroconductive film measured as described is dependent on the kind and amount of the lower valent element added and is not particularly limited, but is preferably 5.0×10¹³ Ω/sq. or less, more preferably 1.0 Ω/sq×10¹⁰ to 5.0×10¹³ Ω/sq, before storage.

The core particle that can be used in the electroconductive particles of the invention may be of an either electrically conductive or non-conductive core material.

The non-electroconductive core materials may be either organic or inorganic. As used herein, the term “non-electroconductive” is intended to mean to have a resistivity, e.g., of 10⁵ Ω·cm or more. Examples of inorganic non-electroconductive core materials include oxides, nitrides, and carbides of various elements and salts of various elements. The various elements include various metal elements. The organic non-electroconductive core materials are typified by polymers. The core material may be either water soluble or insoluble. Taking into consideration the methods for producing electroconductive particles hereinafter described, the core material is advantageously water insoluble. Inorganic core materials are preferred. Specific examples of inorganic core materials include oxides, such as Al₂O₃, TiO₂, and SiO₂, and metal salts, such as BaSO₄. In the case of TiO₂, it may be any of rutile, anatase, and brookite phases.

The core particle may have any shape that allows formation of an electroconductive tin oxide surface layer thereon. The shape is selected from spherical, polyhedral, flaky, acicular, and so forth according to the use of the electroconductive particles. Because the thickness of the surface layer is very small compared with the size of the core particle, the core particle and the electroconductive particle are usually regarded to be generally equal in size.

The electroconductive particles of the invention are advantageously produced by methods 1 and 2 described below.

### Method 1:

A method including the steps of

mixing a slurry containing core particles dispersed in a medium and a tin source compound,

adjusting the pH of the resulting mixed slurry to form a tin-containing precipitate on the surface of the core particles to provide precipitate-coated particles,

adding a compound as a source of an element whose valence is equal to or smaller than four to the mixed slurry to supply the element to the precipitate-coated particles, and

firing the precipitate-coated particles, and

in the step of forming a precipitate on the surface of the core particles, the mixed slurry is subjected to a shear force in a homogenizer, or

the mixed slurry is irritated with an ultrasonic.

### Method 2:

A method including the steps of

mixing a slurry containing core particles dispersed in a medium, a tin source compound, and a compound as a source of an element whose valence is equal to or smaller than four,

adjusting the pH of the resulting mixed slurry to form a coprecipitate containing tin and the element whose valence is equal to or smaller than four on the surface of the core particles to provide coprecipitate-coated particles, and

firing the coprecipitate-coated particles, and

in the step of forming a coprecipitate on the surface of the core particles, the mixed slurry is subjected to a shear force in a homogenizer, or

the mixed slurry is irritated with an ultrasonic.

First, method 1 is explained below. In method 1, a slurry containing core particles dispersed in a medium and a tin source compound are mixed. The amount of the core particles in the slurry is preferably 10 g to 100 g, more preferably 30 g to 80 g, per liter of water. The above core particles to water ratio facilitates formation of a uniform tin oxide surface layer. The tin source compound may be a water soluble tin compound. Any water soluble tin compound capable of forming a tin-containing precipitate on the surface of the core particles may be used. For example, sodium stannate or tin tetrachloride can be used. The mixing ratio of the slurry and the tin source compound is preferably such that the Sn concentration in water of the resulting mixed slurry may range from 1 mass % to 20 mass %, more preferably 3 mass % to 10 mass %. In that mixing ratio, it is easier to form a uniform tin oxide layer.

The resulting mixed slurry is then subjected to pH adjustment to neutralize the tin source compound. The pH adjustment is achieved by the addition of an acid or a base. An acidic or basic substance may be added to the slurry to carry out the neutralization. The acidic substance is exemplified by sulfuric acid, nitric acid, and acetic acid. In using sulfuric acid, dilute sulfuric acid is preferably used for ease of forming a uniform tin oxide layer. The concentration of the dilute sulfuric acid is usually 10 to 50 vol %. Examples of suitable basic substances are sodium hydroxide and aqueous ammonia, with sodium hydroxide being preferred for ease of concentration control. Upon neutralization of the tin source compound, a precipitate containing tin is deposited on the surface of the core particles to provide precipitate-coated particles. The pH of the mixed slurry after the neutralization reaction is preferably 0.5 to 5, more preferably 2 to 4, even more preferably 2 to 3.

In the step of neutralizing the tin source compound through pH adjustment of the mixed slurry thereby to form a tin-containing precipitate on the core particles, it is advantageous to apply a shear force to the mixed slurry in a homogenizer or ultrasonicate the mixed slurry. The inventors have found such a treatment effective in suppressing reduction of the tin oxide crystallite size due to the addition of the lower valent element. The shearing or ultrasonic treatment is particularly effective in using a lower valent element of the type that reduces the tin oxide crystallite size with an increase of its amount of addition. In contrast, when in using a lower valent element of the type that increases the tin oxide crystallite size with an increase of its amount of addition, these treatments are often unnecessary as will be confirmed in Example 3 given later. The shearing or ultrasonic treatment is preferably carried out using a reaction apparatus equipped, in a part of its circulation path, with a homogenizer or an ultrasonic oscillator. While the mixed slurry containing the tin source compound is circulated through the circulation path, an acidic or basic substance may be added at the location of the homogenizer or ultrasonic oscillator. In another preferred embodiment, an ultrasonic oscillator may be provided in a mother liquid tank to apply ultrasonic waves directly to the mixed slurry.

The rotational speed of the homogenizer is preferably 5000 rpm or higher, more preferably 10000 rpm or higher. Although there is no particular upper limit of the rotational speed (the higher the better), effective suppression of reduction in tin oxide crystallite size due to the addition of a lower valent element will be obtained at a high rotation speed of about 16000 rpm. The ultrasonic oscillator is preferably operated at a frequency of 10 kHz to 10 MHz, more preferably 20 kHz to 5 MHz, even more preferably 20 kHz to 50 kHz, with an output power of 50 W to 20 kW, more preferably 500 W to 4000 W.

The reaction apparatus having a homogenizer or an ultrasonic oscillator in a part of its circulation path is described, e.g., in JP 2009-255042A and JP 2010-137183A, both commonly assigned with the present invention.

As a result of the neutralization reaction of the tin source compound, particles each composed of a core particle having the precipitate of the tin compound deposited on the surface thereof, i.e., precipitate-coated particles are obtained. A lower valent element source compound is then added to the mixed slurry to supply the lower valent element to the precipitate-coated particles. The source compound is preferably a water soluble compound. The compound may be added in the form of an aqueous solution or may be added in the form of a solid and dissolved in the mixed slurry. In using aluminum as a lower valent element, for example, aluminum chloride may be used as the source compound.

After addition of the lower valent element source compound to the mixed slurry, the mixed slurry is stirred or otherwise treated to deposit the lower valent element onto the surface of the precipitate-coated particles. The lower valent element is deposited in the form of its ion or in the form of a precipitate, e.g., of a hydroxide or an oxyhydroxide. In the case where a lower valent element which is hard to be deposited is used, pH adjustment may be performed using an acid or a base to accelerate deposition.

There are thus obtained precipitate-coated particles each composed of a core particle coated with the tin-containing precipitate, which are precursor particles of the electroconductive particles of the invention. The precursor particles are washed with water, dewatered by filtration, and dried.

The dried precursor particles are fired. The firing atmosphere may be inert, reductive, or oxidative. Firing in a reductive atmosphere gives desired electroconductive particles at a relatively low firing temperature. In the case when an inert or oxidative atmosphere is chosen, it is desirable to raise the firing temperature over that employed for the firing in a reductive atmosphere. It has been ascertained by the inventors that, when the firing is carried out in a reductive atmosphere, the tin oxide crystallite size can easily be adjusted to fall within a desired range by virtue of an interaction with the lower valent element contained in the precipitate. A reductive atmosphere is exemplified by a nitrogen atmosphere containing hydrogen in a concentration less than an explosion limit. The hydrogen concentration in the nitrogen atmosphere containing hydrogen (less than an explosion limit) is preferably 0.1 vol % to 10 vol %, more preferably 1 vol % to 3 vol %. With the hydrogen concentration ranging within that range, reduction in tin oxide crystallite size due to the addition of the lower valent element can effectively be suppressed without reducing tin to metallic tin.

The firing temperature in a reductive atmosphere is preferably higher than 400° C. and not higher than 1200° C., more preferably 500° C. to 900° C. The firing temperature in an inert or oxidative atmosphere is preferably at least 150° C. higher than the above described firing temperature in a reductive atmosphere. Provided that the firing temperature is within the range recited above, the firing time is preferably 5 minutes to 60 minutes, more preferably 10 minutes to 30 minutes. Under these preferred firing conditions, reduction in tin oxide crystallite size due to the addition of the lower valent element can effectively be minimized while preventing sintering of tin oxide.

Method 2 is explained below. Method 2 is different from method 1 in that a slurry containing core particles dispersed in a medium is mixed with a tin source compound and a lower valent element source compound in the step of mixing. On adjusting the pH of the resulting mixed slurry, a coprecipitate containing tin and the lower valent element is formed on the surface of the core particles to give coprecipitate-coated particles. In the step of forming a coprecipitate on the surface of the core particles, the mixed slurry is subjected to a shear force in a homogenizer, or is irritated with an ultrasonic. The resulting coprecipitate-coated particles are fired in the same manner as in method 1 to provide desired electroconductive particles of the invention.

The electroconductive particles of the invention are useful in a wide variety of application fields, such as printer- or copier-related charger rollers, fixing rollers, paper feed rollers, toners, and electrostatic brushes; flat panel displays, CRTs, and Braun tubes; paints, inks, and emulsions.

The electroconductive particles of the invention are also useful in the form of an electroconductive composition containing the same. For example, the electroconductive particles may be mixed with a resin, a solvent, glass flit, and so on to prepare an electroconductive paste, or the electroconductive particles may be mixed with an organic solvent, a polymerizable monomer or an oligomer or polymer of the monomer, and so forth to prepare an ink. The electroconductive paste or ink is applied to a substrate in a desired pattern to form an electroconductive film containing the electroconductive particles. In some cases, an outer force applied to the electroconductive particles during mixing may cause part or the whole of the tin oxide surface layer to come off the core particles. If this is the case, the electroconductive particles of the invention take on the form of an electroconductive composition comprising particulate tin oxide containing a lower valent element and core particles, in which the tin oxide containing the lower valent element has a crystallite size of 5 nm to 20 nm. In such an electroconductive composition, the core particles may have part of the tin oxide containing a lower valent element located on the surface thereof, which depends on the degree of the outer force imposed.

### EXAMPLES

The present invention will now be illustrated in greater detail with reference to Examples, but it should be understood that the invention is not construed as being limited thereto. Unless otherwise noted, all the percents are given by mass.

### Example 1

In 3 L of water were dispersed 200 g of titanium oxide particles having an average primary particle size of 200 nm as core particles to prepare a slurry. To the slurry was added and dissolved 208 g of sodium stannate (Na₂SnO₃) having a tin content of 41% to obtain a mixed slurry. The mixed slurry was circulated and treated with ultrasonic waves generated by an ultrasonic oscillator provided at a part of the circulation path. The ultrasonic oscillator was operated at a frequency of 40 kHz and an output power of 570 W. While the circulating mixed slurry was ultrasonic-treated, 20% dilute sulfuric acid was added thereto to neutralize tin. Addition of the dilute sulfuric acid was continued over 60 minutes until the pH of the mixed slurry was brought to 2.5. After the neutralization, 0.97 g of zinc (II) chloride (98% purity) was added to the mixed slurry, followed by stirring to obtain precursor particles of electroconductive particles. The precursor particles were washed with warm water and dewatered by filtration. The filter cake of the precursor particles, which are collected by filtration, was put in a horizontal tubular furnace and fired in a 2 vol % H₂/N₂ reductive atmosphere at 500° C. for 1 hour to obtain desired electroconductive particles.

### Example 2

Electroconductive particles were obtained in the same manner as in Example 1, except for changing the amount of zinc chloride as shown in Table 1.

### Example 3

Electroconductive particles were obtained in the same manner as in Example 2, except that the ultrasonic treatment was not conducted.

### Examples 4 to 9

Electroconductive particles were obtained in the same manner as in Example 1, except for using aluminum chloride hexahydrate (aluminum chloride purity: 97%) in place of the zinc chloride in the amount shown in Table 1.

### Example 10

Electroconductive particles were obtained in the same manner as in Example 1, except that, after neutralization (adjustment to pH 2.5 by the addition of dilute sulfuric acid), the mixed slurry was washed with warm water until the conductivity of the washing fluid was 100 μS/cm and then neutralized to a pH of 6 with NaOH, followed by filtration and drying.

### Example 11

Electroconductive particles were obtained in the same manner as in Example 1, except for using barium sulfate as a core material and using an aqueous solution of titanium (IV) sulfate (titanium sulfate purity: 24%) in place of the zinc chloride in the amount shown in Table 1.

### Example 12

Electroconductive particles were obtained in the same manner as in Example 1, except for using magnesium chloride hexahydrate (magnesium chloride purity: 99%) in place of the zinc chloride in the amount shown in Table 1, and, then, adding NaOH until the pH was brought to 10, followed by washing, filtration and drying.

### Example 13

Electroconductive particles were obtained in the same manner as in Example 1, except for using calcium chloride (calcium chloride purity: 95%) in place of the zinc chloride in the amount shown in Table 1.

### Example 14

Electroconductive particles were obtained in the same manner as in Example 1, except for using barium chloride dihydrate (barium chloride purity: 98.5%) in place of the zinc chloride in the amount shown in Table 1 and then, adding NaOH until the pH was brought to 11, followed by washing, filtration and drying.

### Example 15

Electroconductive particles were obtained in the same manner as in Example 1, except that, after neutralization (adjustment to pH 2.5 by the addition of dilute sulfuric acid), the mixed slurry was washed with warm water until the conductivity of the washing fluid was 100 μS/cm and then neutralized to a pH of 6 with KOH, followed by filtration and drying.

### Example 16

Electroconductive particles were obtained in the same manner as in Example 1, except for using zirconium chloride (zirconium chloride purity: 98%) in place of the zinc chloride in the amount shown in Table 1 and then, adding NaOH until the pH was brought to 9, followed by washing, filtration and drying.

### Example 17

Electroconductive particles were obtained in the same manner as in Example 1, except for using boric acid (boric acid purity: 99.5%) in place of the zinc chloride in the amount shown in Table 1.

### Comparative Example 1

Electroconductive particles were obtained in the same manner as in Example 1, except that zinc chloride was not added and that the ultrasonic treatment was not performed.

### Comparative Example 2

Electroconductive particles were obtained in the same manner as in Example 4, except that the ultrasonic treatment was not performed.

### Comparative Example 3

Electroconductive particles were obtained in the same manner as in Example 4, except that the amount of the aluminum chloride was changed as shown in Table 1 and that the ultrasonic treatment was not performed.

### Evaluation:

The electroconductive particles obtained in Examples and Comparative Examples were examined by the methods described supra for tin oxide content in the electroconductive particles, lower valent element content relative to tin, average primary particle size, D₅₀ and D₉₀ (particle size at 50% and 90% cumulative volume in the particle size distribution measured by a laser diffraction scattering method), crystallite size of tin oxide, BET specific surface area of the electroconductive particles, powder resistivity under pressure, and pre-storage surface resistivity and surface resistivity change of an electroconductive film prepared using the electroconductive particles. The results obtained are shown in Table 2.

TABLE 1

| | Core Particle | | Lower Valent Element | | |
|---|---|---|---|---|---|
| | | Average Primary | | Amount | Ultrasonic |
| | Material | Particle Size (nm) | Kind | (mol % w.r.t. Sn) | Treatment |
| Example 1 | titanium oxide | 200 | Zn | 1 | yes |
| Example 2 | titanium oxide | 200 | Zn | 4 | yes |
| Example 3 | titanium oxide | 200 | Zn | 4 | no |
| Example 4 | titanium oxide | 200 | Al | 1 | yes |
| Example 5 | titanium oxide | 200 | Al | 4 | yes |
| Example 6 | titanium oxide | 200 | Al | 6 | yes |
| Example 7 | titanium oxide | 200 | Al | 7 | yes |
| Example 8 | titanium oxide | 200 | Al | 8 | yes |
| Example 9 | titanium oxide | 200 | Al | 12 | yes |
| Example 10 | titanium oxide | 200 | Na | 8 | yes |
| Example 11 | barium sulfate | 80 | Ti | 2 | yes |
| Example 12 | titanium oxide | 200 | Mg | 2 | yes |
| Example 13 | titanium oxide | 200 | Ca | 2 | yes |
| Example 14 | titanium oxide | 200 | Ba | 2 | yes |
| Example 15 | titanium oxide | 200 | K | 8 | yes |
| Example 16 | titanium oxide | 200 | Zr | 2 | yes |
| Example 17 | titanium oxide | 200 | B | 8 | yes |
| Comparative | titanium oxide | 200 | — | — | no |
| Example 1 | | | | | |
| Comparative | titanium oxide | 200 | Al | 1 | no |
| Example 2 | | | | | |
| Comparative | titanium oxide | 200 | Al | 2 | no |
| Example 3 | | | | | |

TABLE 2

| | | | | | | | | | | | Electroconductive | |
|---|---|---|---|---|---|---|---|---|---|---|---|---|
| | Electroconductive Particles | | | | | | | | | | Film | |
| | | | Amount | Lower Valent | Average | | | | | Powder | Pre- | |
| | Tin | Amount | of Lower | Element | Primary | | | | Specific | Resistivity | storage | Surface |
| | Oxide | of Tin | Valent | Content | Particle | | | Tin Oxide | Surface | under | Surface | Resis- |
| | Content | Oxide | Element | (mol % | Size | D₅₀ | D₉₀ | Crystallite | Area | pressure | Resistivity | tivity |
| | (mass %) | (mol/g) | (mol/g) | w.r.t. Sn) | (nm) | (μm) | (μm) | Size (nm) | (m²/g) | (Ωcm) | (Ω/sq.) | Change |
| Example 1 | 35 | 0.0023 | 0.000021 | 0.9 | 230 | 0.39 | 0.72 | 6.2 | 23.3 | 1.80E+03 | 5.60E+10 | 1.3 |
| Example 2 | 35 | 0.0023 | 0.000081 | 3.5 | 230 | 0.51 | 1.04 | 7.0 | 22.3 | 1.80E+04 | 2.50E+11 | 1.6 |
| Example 3 | 35 | 0.0023 | 0.000083 | 3.6 | 230 | 0.60 | 1.30 | 6.0 | 24.3 | 2.30E+04 | 4.00E+11 | 5.5 |
| Example 4 | 35 | 0.0023 | 0.000026 | 1.1 | 230 | 0.40 | 0.83 | 7.1 | 20.6 | 1.20E+04 | 3.00E+11 | 1.7 |
| Example 5 | 36 | 0.0024 | 0.000096 | 4.1 | 230 | 0.47 | 0.91 | 6.5 | 24.8 | 5.60E+05 | 2.60E+12 | 1.2 |
| Example 6 | 36 | 0.0024 | 0.000133 | 5.7 | 230 | 0.48 | 0.94 | 6.4 | 25.9 | 1.80E+06 | 7.30E+12 | 1.8 |
| Example 7 | 36 | 0.0024 | 0.000156 | 6.5 | 230 | 0.51 | 1.07 | 7.2 | 18.7 | 4.90E+06 | 9.20E+12 | 2.5 |
| Example 8 | 35 | 0.0023 | 0.000185 | 8.0 | 230 | 0.49 | 0.97 | 7.2 | 26.6 | 1.10E+07 | 1.20E+13 | 2.0 |
| Example 9 | 35 | 0.0023 | 0.000222 | 9.7 | 230 | 0.49 | 0.97 | 6.3 | 16.1 | 2.30E+07 | 1.50E+13 | 2.2 |
| Example 10 | 30 | 0.0020 | 0.000126 | 6.4 | 210 | 0.38 | 0.74 | 6.6 | 17.9 | 2.70E+06 | 8.00E+12 | 2.5 |
| Example 11 | 45 | 0.0030 | 0.000054 | 1.8 | 100 | 0.26 | 0.46 | 6.9 | 30.2 | 2.20E+03 | 7.00E+10 | 1.7 |
| Example 12 | 35 | 0.0023 | 0.000173 | 7.5 | 230 | 0.47 | 0.94 | 7.7 | 16.1 | 3.04E+06 | 8.20E+12 | 1.8 |
| Example 13 | 35 | 0.0023 | 0.000005 | 0.2 | 230 | 0.47 | 0.95 | 8.0 | 16.4 | 1.58E+02 | 4.20E+09 | 2.3 |
| Example 14 | 34 | 0.0023 | 0.000138 | 6.1 | 230 | 0.47 | 0.92 | 7.6 | 16.3 | 4.30E+02 | 8.10E+09 | 1.2 |
| Example 15 | 35 | 0.0023 | 0.000147 | 6.4 | 230 | 0.44 | 0.99 | 6.3 | 17.1 | 4.20E+05 | 6.60E+12 | 1.3 |
| Example 16 | 35 | 0.0023 | 0.000046 | 2.0 | 230 | 0.47 | 0.95 | 7.0 | 18.6 | 4.80E+04 | 1.98E+11 | 2.6 |
| Example 17 | 35 | 0.0023 | 0.000136 | 5.9 | 230 | 0.47 | 0.96 | 6.5 | 20.8 | 4.20E+04 | 9.80E+11 | 1.8 |
| Comparative | 37 | 0.0024 | — | — | 230 | 0.93 | 1.77 | 5.6 | 23.3 | 3.40E+02 | 5.00E+09 | 20.0 |
| Example 1 | | | | | | | | | | | | |
| Comparative | 35 | 0.0023 | 0.000022 | 1.0 | 230 | 0.83 | 1.21 | 4.9 | 23.0 | 7.00E+03 | 7.00E+10 | 7.1 |
| Example 2 | | | | | | | | | | | | |
| Comparative | 35 | 0.0023 | 0.000044 | 1.9 | 230 | 0.92 | 1.91 | 4.3 | 25.3 | 1.30E+04 | 7.00E+11 | 8.2 |
| Example 3 | | | | | | | | | | | | |

As is apparent from the results in Table 2, the electroconductive particles obtained in Examples provide an electroconductive film of which the increase in surface resistivity due to storage in a high temperature and high humidity environment is suppressed.

It is seen from the results of Examples 1 to 3 that, when zinc that causes an increase of the tin oxide crystallite size with its amount added is used as a lower valent element, electroconductive particles with good performance are obtained even if the particles are produced without performing an ultrasonic treatment.

On the other hand, when aluminum that causes a decrease of the tin oxide crystallite size with its amount added is used as a lower valent element, the performance of the electroconductive particles is reduced if produced without an ultrasonic treatment as revealed by the results of Examples 4 to 9 and Comparative Examples 2 and 3.

1. An electroconductive particle comprising a core particle and tin oxide containing at least one element whose valence is equal to or smaller than four and located on the surface of the core particle,
the tin oxide containing at least one element whose valence is equal to or smaller than four having a crystallite size of 5 nm to 20 nm.

2. The electroconductive particle according to claim 1, wherein the tin oxide containing at least one element whose valence is equal to or smaller than four has a content of the element of 0.045 mol % to 20 mol % relative to tin.

3. The electroconductive particle according to claim 1, wherein the element is an element of the group 1 of the Periodic Table, an element of the group 2 of the Periodic Table, an element of the group 4 of the Periodic Table, an element of the group 12 of the Periodic Table, or an element of the group 13 of the Periodic Table.

4. The electroconductive particle according to claim 3, wherein the element of the group 1 of the Periodic Table is sodium, potassium, or lithium,
the element of the group 2 of the Periodic Table is magnesium, calcium, or barium,
the element of the group 4 of the Periodic Table is titanium, zirconium, or hafnium,
the element of the group 12 of the Periodic Table is zinc, and
the element of the group 13 of the Periodic Table is boron, aluminum, or gallium.

5. The electroconductive particle according to claim 1, wherein, upon forming an electroconductive film using the electroconductive particle together with a resin and a solvent and storing the film at 60° C. and 90% RH for 30 days, the ratio of a post-storage surface resistivity R_{HH} (Ω/sq.) to a pre-storage resistivity R (Ω/sq.), R_{HH}/R, is 5 or less.

6. The electroconductive particle according to claim 1, wherein the proportion of tin oxide in the electroconductive particle is 10 mass % to 60 mass %.

7. The electroconductive particle according to claim 1, having an average primary particle size of 30 nm to 700 nm measured by electron microscopic observation.

8. An electroconductive composition comprising the electroconductive particle according to claim 1.

9. An electroconductive composition comprising a particulate tin oxide containing at least one element whose valence is equal to or smaller than four and a core particle,
the tin oxide containing at least one element whose valence is equal to or smaller than four having a crystallite size of 5 nm to 20 nm.

10. The electroconductive composition according to claim 9, wherein a part of the tin oxide containing at least one element whose valence is equal to or smaller than four is located on the surface of the core particle.

11. An electroconductive film comprising the electroconductive particle according to claim 1.
